(19) United States
(12) Patent Application Publication
(10) Pub. No.: US 2007/0066136 A1
(43) Pub. Date: Mar. 22, 2007

(54) ELECTRIC CONNECTOR

(76) Inventor: BYOUNG-ROCK KIM, Suwon-City Kyungki-do (KR)

Correspondence Address: IPLA P.A., 3580 WILSHIRE BLVD., 17TH FLOOR, LOS ANGELES, CA, 90010, US

(21) Appl. No.: 11/163,712

(22) Filed: Oct. 27, 2005

(30) Foreign Application Priority Data
Sep. 22, 2005 (KR) 10-2005-0087924

(51) Int. Cl. H01R 13/648

(52) U.S. Cl. 439/607

(57) ABSTRACT

“The electric connector includes a main body, which has upper and lower guide surfaces facing each other. An insertion slot is formed in a first surface of the main body. The electric connector further includes main terminal contacts which are fastened to the main body. Each main terminal contact protrudes outside at a second end thereof from a second surface opposite the first surface of the main body. A contact part is provided on a first end of the main terminal contact which is horizontal and oriented towards the first surface of the main body and is spaced apart from the upper and lower guide surfaces by predetermined distances. The electric connector further includes a conductive cover which surrounds an outer surface of the main body. A contact guide protrudes from the conductive cover and is bent inwards towards the main body.”

### BACKGROUND OF THE INVENTION

1. Field of the Invention

The present invention relates generally to electric connectors which are used for connecting flexible cables or substrates to printed circuit boards and, more particularly, to an electric connector which has an improved structure and is used for transmitting electromagnetic signals.

2. Description of the Related Art

As well known to those skilled in the art, a plug connector and a socket connector are coupled to each other to transmit electromagnetic signals. A plurality of main terminal contacts is installed in a line in the socket connector. Such a socket connector includes contacts serving a grounding function and contacts serving an electric signal transmission function. Generally, electric connectors, which are constructed such that the two kinds of contacts face each other, have been widely used.

As such, in a conventional electric connector, two kinds of contacts are arranged in lines at upper and lower positions and face each other. Due to such a construction, a large number of contacts serving a grounding function must be manufactured through a separate process and linearly disposed in the electric connector. Furthermore, the larger number of contacts for grounding increases the manufacturing cost of the electric connector. To solve these problems, a ground contact having a simple shape is required, or, there is a necessity for replacement with an electric connector, which can securely conduct a grounding function despite having a small and simple construction.

To meet the needs, an electric connector having an improved ground contact was proposed in Korean Utility Model Registration No. 358321, which was filed by the inventor of the present invention. The characteristics of this technique are as follows. A conductive cover surrounds the outer surface of the electric connector. Only two ground contacts are placed at outside opposite ends of the electric connector, unlike prior arts. Normal contacts are disposed inline between the ground contacts. Each ground contact is bent upwards, that is, towards the upper surface of the conductive cover, such that the ground contact is in contact with the conductive cover.

However, in the case of this electric connector, there is a disadvantage in that the ground contact must be manufactured through a separate process, unlike the other contacts, such that the ground contact is bent upwards to contact the conductive cover. In an effort to overcome this problem, the inventor of the present invention proposed a technique, which was submitted as Korean Patent Application No. 2004-111223 and was registered as Korean Patent Registration No. 486990. The characteristics of this technique are as follows.

This technique simplifies the shape of a ground contact. In detail, the ground contact has a shape similar to that of other normal contacts, but a contact end thereof is shorter than the normal contacts. Thus, the electric connector according to this technique meets standard requirements of the LCD dimension and the ISP (industrial standard panel) guidelines, which are recommended for portable devices such as notebook computers. As well, the electric connector prevents parts from undesirably contacting a plug connector, thus preventing friction from occurring, and reducing the incidence of malfunction.

The above-mentioned techniques have such advantageous characteristics, but a further developed electric connector, which can conduct a grounding function using a contact with a conductive cover despite having a ground contact with a simple construction, is still required. To achieve the purpose, the present invention provides an electric connector that is improved over the above-mentioned prior arts.

### SUMMARY OF THE INVENTION

Accordingly, the present invention has been made keeping in mind the above problems occurring in the prior art, and an object of the present invention is to provide an electric connector, in which a main body and a conductive cover that surrounds the main body have improved shapes, thus preventing parts from undesirably contacting a plug connector, meeting standard requirements for connectors, and conducting a grounding function using contact between a ground contact and the conductive cover.

Another object of the present invention is to provide an electric connector which has an improved structure such that the improved conductive cover and main body can be smoothly coupled to each other.

In order to accomplish the above objects, the present invention provides an electric connector, including: a main body, having upper and lower guide surfaces facing each other at upper and lower positions, with an insertion slot formed in a first surface of the main body; a plurality of main terminal contacts fastened to the main body and being parallel with the main body, each main terminal contact protruding outside at a second end thereof from a second surface opposite the first surface of the main body, with a contact part provided on a first end of the main terminal contact which is horizontal and oriented towards the first surface of the main body and is spaced apart from the upper and lower guide surfaces by predetermined distances; and a conductive cover surrounding an outer surface of the main body, with a contact guide protruding from the conductive cover and being bent inwards towards the main body.

The contact guide may have an elongated terminal shape perpendicularly protruding from an edge of the conductive cover.

The contact guide may protrude towards the second surface of the main body and is bent towards the main body, and an end of the contact guide is in contact with one main terminal contact.

The contacts, placed at opposite ends of a row of the main terminal contacts, may comprise ground contacts fastened to the main body, and each ground contact may protrude outside at a second end thereof from the second surface of the main body, while protruding at a first end thereof towards the first surface of the main body to a predetermined distance less than the other main terminal contacts, or while not protruding at the first end thereof. Furthermore, the contact guide may protrude towards the second surface of the main body and is bent towards the main body, so that an end of the contact guide is in contact with the ground contacts of the main terminal contacts.

The electric connector may further include an elongated slot formed in one of the upper and lower guide bodies of the main body and extending towards both the first surface and the second surface of the main body, so that, when the conductive cover is coupled to the main body, the contact guide of the conductive cover is inserted into the elongated slot of the main body.

The electric connector may further include: an elongated slot formed in one of the upper and lower guide surfaces of the main body and extending towards both first surface and the second surface of the main body; and a contact seat formed inside the elongated slot and extending in a horizontal direction, so that one main terminal contact is inserted into the contact seat. Thus, when the conductive cover is coupled to the main body, the contact guide of the conductive cover is inserted into the elongated slot of the main body and is brought into contact with the main terminal contact inserted in the contact seat.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view showing the external shape of an electric connector, according to an embodiment of the present invention;

FIG. 2 is a perspective view of a conductive cover of the electric connector of FIG. 1;

FIG. 3 is a perspective view showing an enlargement of a portion of the conductive cover of FIG. 2 centered on a contact guide;

FIG. 4 is a front view showing a second surface of the electric connector of FIG. 1;

FIG. 5a is a sectional view taken along the line A-A of FIG. 4;

FIG. 5b is a sectional view taken along the line B-B of FIG. 4;

FIG. 6 is a perspective view showing a portion of a main body of the electric connector according to the present invention;

FIG. 7a is a perspective view showing a ground contact mounted to the main body of FIG. 6; and

FIG. 7b is a sectional view taken along the line C-C of FIG. 7a.

### DESCRIPTION OF THE PREFERRED EMBODIMENTS

Hereinafter, a preferred embodiment of the present invention will be described in detail with reference to the attached drawings.

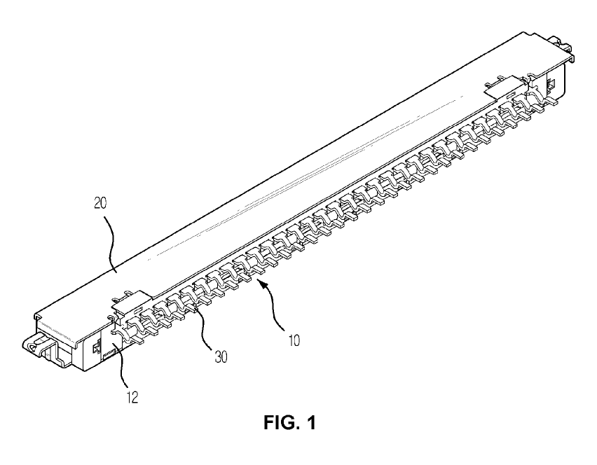

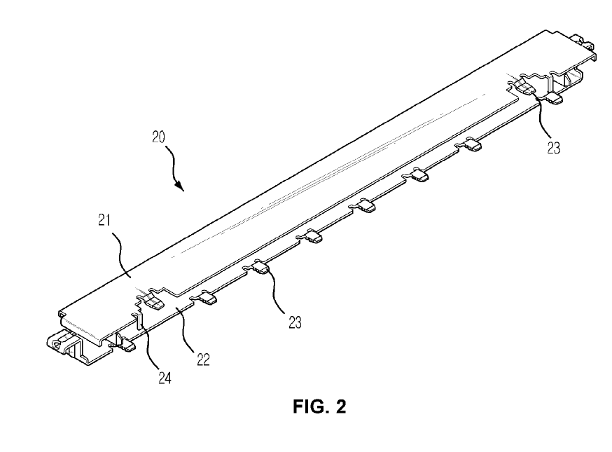

FIG. 1 is a perspective view showing the external shape of an electric connector, according to the preferred embodiment of the present invention. FIG. 2 is a perspective view of a conductive cover of the electric connector of FIG. 1. Referring to FIGS. 1 and 2, the electric connector according to the preferred embodiment of the present invention includes a main body 10, to which a plurality of main terminal contacts 30 is mounted, and a conductive cover 20 which surrounds the main body 10. A mounting lead of each main terminal contact 30 protrudes outwards from a second surface 12 of the main body 10. The electric connector is constructed such that a separate plug connector (not shown) is inserted into the electric connector through a surface of the main body 10 opposite to the second surface 12. The main body 10 is made of synthetic resin and is manufactured through a molding process.

The conductive cover 20 is made of metal such as aluminum. The conductive cover 20 comprises an upper surface 21 and a lower surface 22 which have a plurality of coupling protrusions 23, such that the main body 10 is securely fitted into the conductive cover 20. That is, when the conductive cover 20 is coupled to the main body 10 so as to surround the main body 10, the coupling protrusions 23 of the conductive cover 20 are inserted into grooves formed in the main body 10, so that the main body 10 and the conductive cover 20 are securely coupled to each other. Furthermore, the conductive cover 20 includes two contact guides 24 which protrude from a front edge of opposite ends of the upper surface 21 and are bent downwards. The contact guides 24 are integrated with the conductive cover 20. Each contact guide 24 has a thin elongated stick shape.

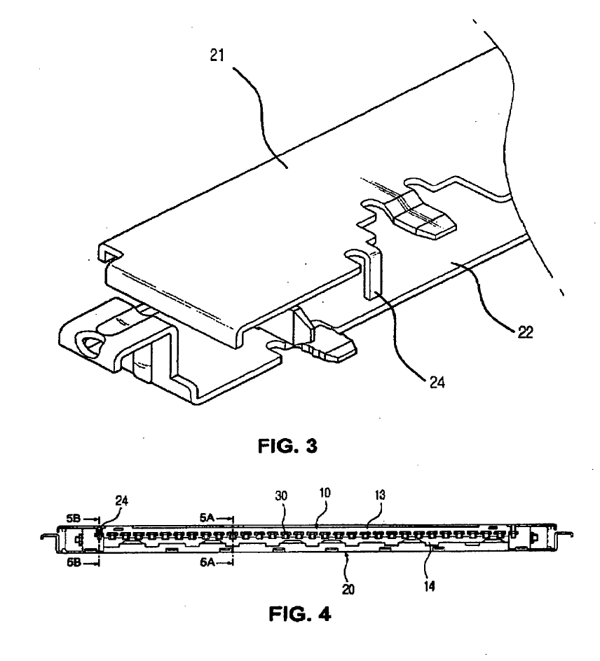

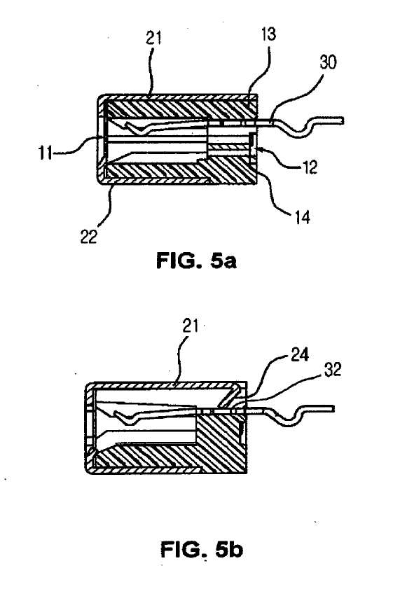

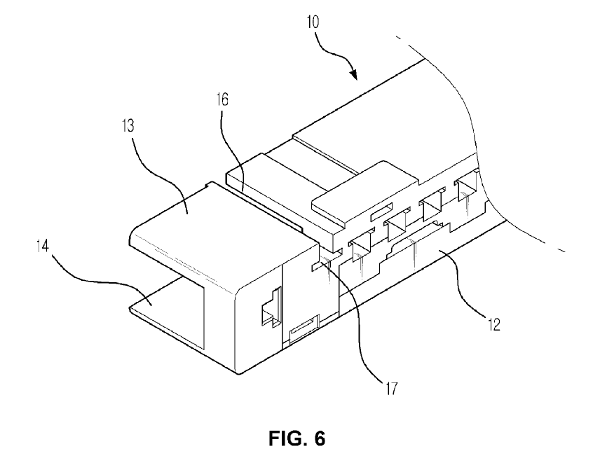

FIG. 3 is a perspective view showing an enlargement of a portion of the conductive cover 20 centered on the contact guide 24. FIG. 4 is a front view showing the second surface 12 of the electric connector. Referring to FIG. 3, because the contact guide 24, which is bent downwards, is made of conductive metal such as aluminum, the contact guide 24 may be elastically bent forwards or rearwards. Furthermore, the contact guide 24 extends to a position approximately halfway between the upper and lower surfaces 21 and 22 of the conductive cover 20. Referring to FIG. 4, each contact guide 24 is in contact with an outermost one of the main terminal contacts 30, which are arranged inline in a longitudinal direction of the main body 10 between upper and lower guide surfaces 13 and 14 of the main body 10. This contact state is shown in a sectional view of FIG. 5b.

FIGS. 5a and 5b are sectional views showing the inner construction of the electric connector. FIG. 5a is a sectional view taken along the line A-A of FIG. 4. FIG. 5b is a sectional view taken along the line B-B of FIG. 4. Referring to FIG. 5a, each main terminal contact 30 is coupled at an intermediate portion thereof to the main body 10 and is parallel with the main body 10. Furthermore, the main terminal contacts 30 are brought into contact with a plug connector (not shown) to be inserted into a first surface 111 of the main body 10. Referring to FIG. 5b, each contact guide 24 is integrated with the conductive cover 20 and is bent downwards. An end of the contact guide 24 extends to a position at which a ground contact 32 (or a main terminal contact) is positioned. An enlargement of a portion of the main body 10, in which the contact guide 24 is located, will be illustrated herein below.

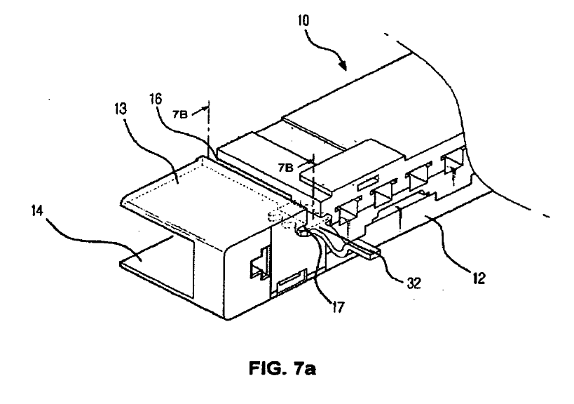

FIG. 6 is a perspective view showing a portion of the main body 10. FIG. 6 shows the enlargement of the portion of the main body 10, when the main terminal contacts 30 and the conductive cover 20 are not mounted to the main body 10. As shown in FIG. 6, a slot 16 is formed in each of opposite ends of the main body 10 and extends from the first surface 11 to the second surface 12. In detail, the slot 16 is formed in the upper guide surface 13. Two contact seats 17 are formed at predetermined positions in the second surface 12 of the main body 10. Each contact seat 17 has a hole shape which horizontally extends to a predetermined depth. A contact is inserted into and held by each contact seat 17. Each slot 16 is open at an upper end thereof and communicates at a lower end thereof with each contact seat 17. The contact, which is disposed in the contact seat 17, is brought into contact with the contact guide 24 protruding downwards from the conductive cover 20.

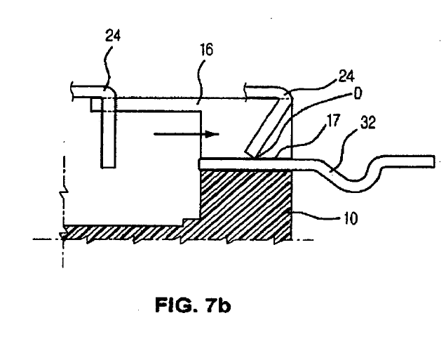

FIGS. 7a and 7b respectively are a perspective view and a sectional view showing the ground contact 32 mounted to the main body 10. Referring to FIG. 7a, a first end of each ground contact 32 is inserted into each contact seat 17. A second end of the ground contact 32 extends a predetermined length outwards from the second surface 12 of the main body 10. The first end of the ground contact 32 does not excessively extend towards the first surface 11 of the main body 10, thus preventing an undesired part from contacting a plug connector. The ground contact 32 is partially exposed through the slot 16 formed in the upper guide surface 13.

FIG. 7b is a sectional view taken along the line C-C of FIG. 7a. Referring to FIG. 7b, to insert the contact guide 24, which extends downwards from the conductive cover 20, into the slot 16 of the main body 10 which is open at the upper end thereof, the contact guide 24 is moved from the first surface 11 (from the left when viewing the drawing) to the second surface 12 of the main body 10. When the contact guide 24 reaches a desired position, the lower end of the contact guide 24 is brought into contact with the open portion (D) of the ground contact 32 and presses the ground contact 32 downwards. The contact guide 24 has a predetermined length such that the lower end thereof can be bent slightly inwards when contacting the ground contact 32, and can press the ground contact 32 downwards.

As such, in the present invention, the ground contact 32 can securely contact the conductive cover 20 in order to execute a grounding function despite having a shape similar to other main terminal contacts 30. Furthermore, the conductive cover 20 is coupled to the main body 10 using the slot 16 through a single process without any particular operation or shape modification. As well, because the contact guide 24 of the conductive cover 20 extends a predetermined length downwards so as to contact the upper surface of the ground contact 32, a separate contact part, protruding towards a surface of the main body 10 through which a plug connector is inserted, is not required. Therefore, an undesired part of the ground contact 32 is prevented from contacting the plug connector. In addition, because thirty-two mounting leads including mounting leads of the ground contacts 32 are arranged inline and protrude outwards from the second surfaces 12 of the main body 10, the present invention can meet the standard requirements of a typical connector.

As described above, the present invention provides an electric connector which has a contact guide which is provided in a conductive cover and is in contact with a ground contact. Therefore, despite having a simple structure, the present invention can prevent parts from undesirably contacting a plug connector, meet standard requirements of the typical connector, and securely conduct a grounding function.

Furthermore, the present invention improves the shape of the conductive cover and a main body, so that the conductive cover and the main body are easily coupled to each other.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. An electric connector, comprising:
a main body, comprising upper and lower guide surfaces facing each other at upper and lower positions, with an insertion slot formed in a first surface of the main body;
a plurality of main terminal contacts fastened to the main body and being parallel with the main body, each main terminal contact protruding outside at a second end thereof from a second surface opposite the first surface of the main body, with a contact part provided on a first end of the main terminal contact which is horizontal and oriented towards the first surface of the main body and is spaced apart from the upper and lower guide surfaces by predetermined distances; and
a conductive cover surrounding an outer surface of the main body, with a contact guide protruding from the conductive cover and being bent inwards towards the main body.

2. The electric connector as set forth in claim 1, wherein the contact guide has an elongated terminal shape protruding from an edge of the conductive cover.

3. The electric connector as set forth in claim 1, wherein the contact guide protrudes towards the second surface of the main body and is bent towards the first surface of the main body, and an end of the contact guide is in contact with one main terminal contact.

4. The electric connector as set forth in claim 1, wherein contacts, placed at opposite ends of a row of the main terminal contacts, comprise ground contacts fastened to the main body, each ground contact protruding outside at a second end thereof from the second surface of the main body, while protruding at a first end thereof towards the first surface of the main body to a predetermined distance less than the other main terminal contacts, or while not protruding at the first end thereof, and
the contact guide protrudes towards the second surface of the main body and is bent towards the main body, so that an end of the contact guide is in contact with the ground contacts of the main terminal contacts.

5. The electric connector as set forth in claim 1, further comprising:
an elongated slot formed in one of the upper and lower guide surfaces of the main body and extending towards both the first surface and the second surface of the main body, so that,
when the conductive cover is coupled to the main body, the contact guide of the conductive cover is inserted into the elongated slot of the main body.

6. The electric connector as set forth in claim 1, further comprising:
an elongated slot formed in one of the upper and lower guide surfaces of the main body and extending towards both the first surface and the second surface of the main body, and
a contact seat formed inside the elongated slot and extending in a horizontal direction, so that one main terminal contact is inserted into the contact seat, wherein, when the conductive cover is coupled to the main body, the contact guide of the conductive cover is inserted into the elongated slot of the main body and is brought into contact with the main terminal contact inserted in the contact seat.

7. The electric connector as set forth in claim 1, wherein the main body is made of synthetic resin.

8. The electric connector as set forth in claim 1, wherein the conductive cover is made of aluminum.

9. An electric connector, comprising:
a main body, comprising upper and lower guide surfaces facing each other at upper and lower positions, with an insertion slot formed in a first surface of the main body;
a plurality of main terminal contacts fastened to the main body and being parallel with the main body, each main terminal contact protruding outside at a second end thereof from a second surface opposite the first surface of the main body, with a contact part provided on a first end of the main terminal contact which is horizontal and oriented towards the first surface of the main body and is spaced apart from the upper and lower guide surfaces by predetermined distances; and
a conductive cover surrounding an outer surface of the main body except the second surface of the main body, with a contact guide protruding from the conductive cover and being elastically bent inwards towards the first surface of the main body.

10. The electric connector as set forth in claim 9, wherein the contact guide is in contact with one of the main terminal contacts.

11. The electric connector as set forth in claim 9, further comprising:
ground contacts at opposite ends of a row of the main terminal contacts, the ground contacts being fastened to the main body, an end of the contact guide being in contact with the ground contacts of the main terminal contacts.

12. The electric connector as set forth in claim 11, wherein the contact guide applies an elastic pressure to the ground contacts.

13. The electric connector as set forth in claim 9, further comprising:
an elongated slot formed in one of the upper and lower guide surfaces of the main body and extending towards both the first surface and the second surface of the main body, wherein the contact guide is inserted into the elongated slot.

14. The electric connector as set forth in claim 9, further comprising:
an elongated slot formed in one of the upper and lower guide surfaces of the main body and extending towards both the first surface and the second surface of the main body; and
a contact seat formed inside the elongated slot, one main terminal contact being inserted into the contact seat, the conductive cover being coupled to the main body, the contact guide being inserted into the elongated slot and being brought into contact with the main terminal contact inserted in the contact seat.

15. The electric connector as set forth in claim 9, wherein the main body is made of synthetic resin.

16. The electric connector as set forth in claim 9, wherein the conductive cover is made of aluminum.
